(19) United States
(12) Patent Application Publication
(10) Pub. No.: US 2020/0202798 A1
(43) Pub. Date: Jun. 25, 2020

(54) Video Pipeline Pixel Analysis for Full Array Local Dimming

(71) Applicant: Lincoln Technology Solutions, Inc., Cary, NC (US)

(72) Inventors: Jacob Warren Kimbrell, Raleigh, NC (US); Dominic Joseph Arnone, Cary, NC (US)

(21) Appl. No.: 16/410,088

(22) Filed: May 13, 2019

Related U.S. Application Data
(60) Provisional application No. 62/784,607, filed on Dec. 24, 2018.
(60) Provisional application No. 62/808,065, filed on Feb. 20, 2019.

(51) Int. Cl. G09G 3/34; G09G 3/36

(52) U.S. Cl. CPC G09G 3/342; G09G 2320/0686; G09G 2360/16; G09G 3/3607

(57) ABSTRACT

Methods and devices to display an image on an LCD display that includes a liquid crystal cell and a light emitting diode backlight. Based on an incoming video stream, data is analyzed to control the amount of light that is emitted by the backlight to one or more zones on the display.

### RELATED APPLICATIONS

This claims priority to U.S. Provisional Application Nos. 62/784,607 filed on Dec. 24, 2018 and 62/808,065 filed on Feb. 20, 2019, each of which is incorporated herein by reference in its entirety.

### BACKGROUND

High-dynamic range (HDR) imaging techniques provide a greater dynamic range of luminosity than traditional imaging techniques. These HDR techniques attempt to mirror the human eye that constantly adapts to a broad range of luminance that is experienced in the environment. Often, HDR imaging is only available with expensive equipment. This equipment may not be financially feasible for all consumers. Further, many video processing components are not capable of supporting these HDR techniques. For example, older components may not be able to support these techniques.

### SUMMARY

One method is directed to a method of displaying an image on a liquid crystal display. The method includes receiving an incoming video stream for displaying the image on the liquid crystal display with the liquid crystal display including a liquid crystal cell with an array of pixels and a light emitting diode (LED) backlight that comprises a plurality of LEDs that backlight the pixels. The liquid crystal display includes zones that each has a portion of the array of pixels and one or more of the LEDs that backlight the portion of the pixels. The method includes calculating a luminance value of the pixels in a first one of the zones. The method includes responsive to the luminance values, adjusting the one or more LEDs that backlight the pixels in the first one of the zones.

One aspect is directed to a method of displaying an image on a liquid crystal display. The method includes receiving an incoming video stream for displaying the image on the liquid crystal display with the liquid crystal displaying including a liquid crystal cell with an array of pixels and a light emitting diode (LED) backlight that comprises a plurality of LEDs that backlight the pixels. The liquid crystal display includes zones that each has a portion of the array of pixels and one or more of the LEDs that backlight the portion of the pixels. The method includes calculating a luminance value of the pixels in one or more of the zones, and responsive to one or more of the luminance values, adjusting the one or more LEDs that backlight the pixels in one or more of the zones.

One aspect is directed to a device to adjust a display of an image on a liquid crystal display that comprises a liquid crystal cell with an array of pixels and a light emitting diode (LED) backlight with a plurality of LEDs that backlight the pixels. The liquid crystal display includes zones that each has a portion of the array of pixels and one or more of the LEDs that backlight the portion of the pixels. The device includes a control circuit configured to receive an incoming video stream. The control circuit calculates a luminance value of the pixels in one or more of the zones, and responsive to one or more of the luminance values, adjust a luminance of the one or more LEDs that backlight the pixels in one or more of the zones.

One aspect is directed to a method of adjusting a brightness of one or more LEDs on an LED backlight that are positioned at a liquid crystal cell having a plurality of pixels. The method includes: calculating a luminance value of each pixel in a zone; calculating an average zone luminance; and adjusting a brightness of each LED based on the average zone luminance.

In another aspect, the method includes setting the brightness of each LED to be equal.

One aspect is directed to a method of adjusting a brightness of one or more LEDs on an LED backlight that are positioned at a liquid crystal cell having a plurality of pixels. The method includes determining a number of pixels in each zone that are off; when the number of pixels in the zone that are off is below a predetermined threshold, turn off an LED that corresponds to the zone; and when the number of pixels in the zone that are off is above the predetermined threshold, maintain the setting of the LED that corresponds to the zone.

One aspect is directed to a method of adjusting a brightness of one or more LEDs on an LED backlight that are positioned at a liquid crystal cell having a plurality of pixels. The method includes: determining a brightness of a plurality of zones; determining that one or more of the zones are bright zones and have a brightness above a first predetermined threshold; determining adjacent zones that are adjacent to the one or more bright zones and that have a brightness above a second predetermined threshold; determining additional zones that are within a predetermined distance of the bright zones and the adjacent zones and that have a brightness above a third predetermined threshold; and adjusting the brightness of the LEDs corresponding to the additional zones.

In another aspect, the method includes that the second predetermined threshold is lower than the first predetermined threshold.

In another aspect, the method includes that the third predetermined threshold is lower than the second predetermined threshold.

In another aspect, determining a brightness a plurality of zones includes determining a brightness of all of the plurality of zones of the LED backlight.

One aspect is directed to a method of adjusting a brightness of one or more LEDs on an LED backlight that are positioned at a liquid crystal cell having a plurality of pixels. The method includes: calculating a brightness value of a plurality of zones; summing the brightness values of each of the plurality of zones; reducing the brightness of each of the zones when the summed brightness value is above a predetermined threshold; and maintaining the brightness of each of the zones when the summed brightness value is below the predetermined threshold.

In another aspect, calculating a brightness value of a plurality of zones includes calculating the brightness value of each of the zones of the LED backlight.

### BRIEF DESCRIPTION OF THE DRAWINGS

FIG. 1 is an exploded diagram of an LCM and an LED backlight of an LCD display.

FIG. 2 is a schematic diagram of an LCM with an array of pixels and sub-pixels.

FIG. 3 is a schematic diagram of an LED backlight.

FIG. 4 is a schematic diagram of zones of pixels that correspond to an LED.

FIG. 5 is a schematic diagram of a control circuit that receives an incoming video stream and outputs streams to an LCM and an LED backlight.

FIG. 6 is a flowchart of a method of displaying an image.

FIG. 7 is a flowchart of a method of average zone luminance.

FIG. 8 is a schematic diagram of an object being displayed by pixels that are arranged in zones.

FIG. 9 is a flowchart of a method of black level improvements for stray on pixels.

FIG. 10 is a flowchart of a method of black level control for halo improvement.

FIG. 11 is a flowchart of a method of black level control for halo improvement.

FIG. 12 is a schematic diagram of the analysis of zones for the method of FIG. 10.

FIG. 13 is a flowchart of a method of max frame luminance.

### DETAILED DESCRIPTION

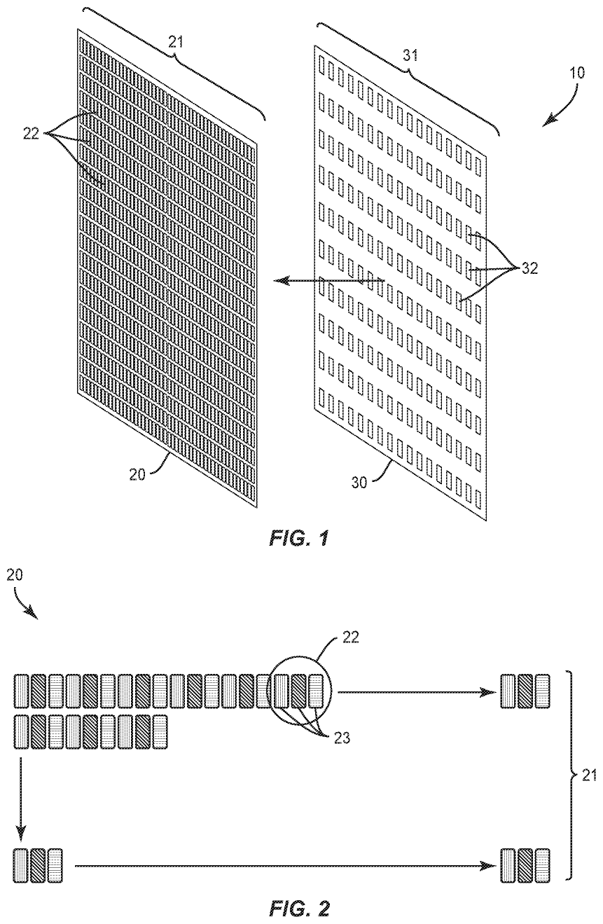

FIG. 1 illustrates a liquid crystal cell 20 and a light emitting diode (LED) backlight 30 of an LCD display 10. The LED backlight 30 is positioned behind and provides backlighting to the liquid crystal cell 20. The LCD display 10 can also include one or more additional layers, including but not limited to optical film, diffusion film, and diffuser plates that are not illustrated in FIG. 1.

The liquid crystal cell 20 includes an array 21 of pixels 22. The array 21 can include various sizes and shapes. One design features a 1920×1080 array (i.e., 1920 pixels in each of the 1080 rows). As illustrated in FIG. 2, each pixel 22 includes multiple sub-pixels 23. In one design, each pixel 22 includes three sub-pixels 23: a red sub-pixel; a green sub-pixel; and a blue sub-pixel (i.e., an RGB pixel). The sub-pixels 23 can be adjusted to different luminance values to cause the pixels 22 to have various colors. One design includes the liquid crystal cell 20 being a 24-bit display that can yield a total of 16.7 million colors.

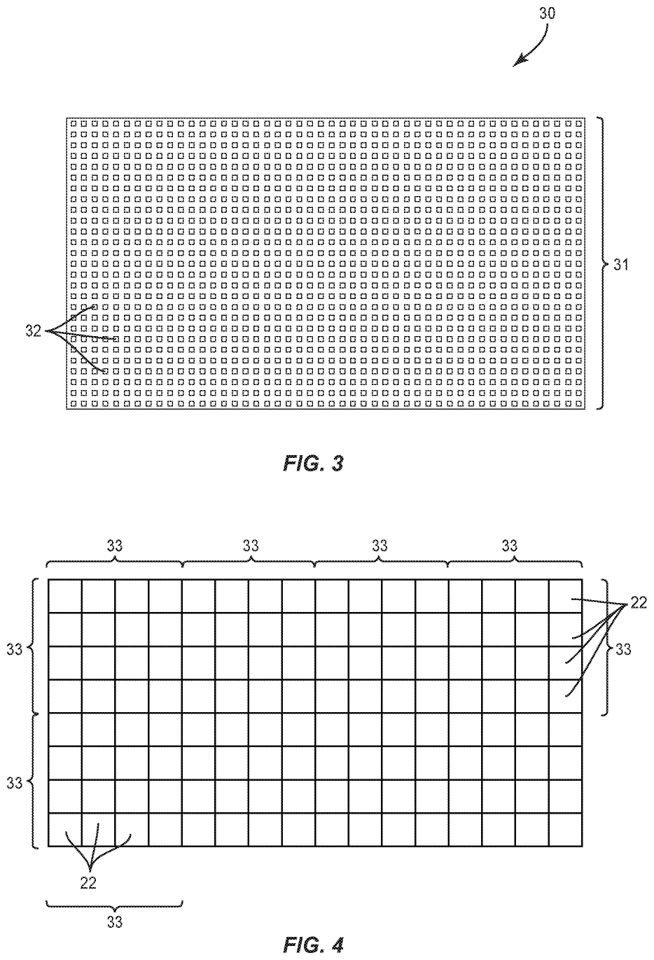

The LED backlight 30 is positioned behind the liquid crystal cell 20 and provides backlighting to the liquid crystal cell 20. As illustrated in FIGS. 1 and 3, the LED backlight 30 includes an array 31 of individual LEDs 32. Each LED 32 is individually controlled to different settings to provide different brightness levels. The array 31 can include a variety of different arrangements of the LEDs 32. One array 31 includes a 48×27 array (i.e., forty-eight LEDs aligned in each of twenty-seven rows). Other designs can include different arrangements, with popular designs including a 16:9 aspect ratio.

The number of LEDs 32 is less than the number of pixels 22. Thus, each LED 32 illuminates a group of pixels 22. As illustrated in FIG. 4, each LED 32 illuminates a zone 33 of pixels 22. FIG. 4 includes each zone 33 having a rectangular shape. Zones 33 can also include various shapes and sizes. Also, the number of pixels 22 corresponding to each zone 33 can vary. The different zones 33 can each include the same or different shapes, sizes, and/or corresponding number of pixels 22. In designs with a 16:9 aspect ratio the zone 33 can have square or rectangular dimensions. In one design, each zone 33 corresponds to a 90×90 group of pixels 22.

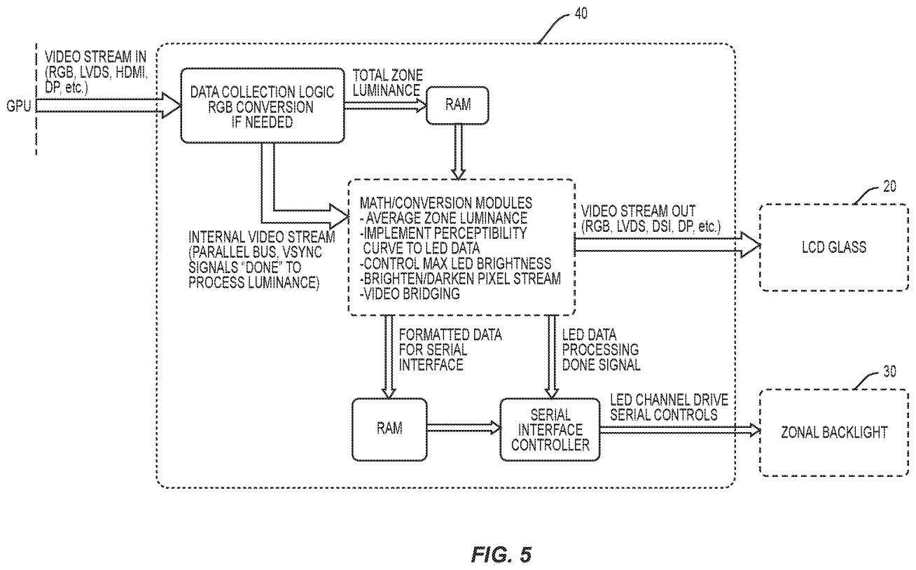

A control circuit 40 controls the operation of the liquid crystal cell 20 and the LED backlight 30. As illustrated in FIG. 5, the control circuit 40 can include a field programmable gate array (FPGA). The FPGA is configured to receive a video stream, process the data, and output data to the LED backlight 30 and to the liquid crystal cell 20.

The FPGA can be configured to perform various functions, including but not limited to calculating conversion data, calculating average zone luminance, implementing a perceptibility curve to LED data, controlling maximum LED brightness, controlling luminance of the pixel stream, and video bridging. The control circuit 40 can include a memory circuit with one or several types of non-transitory memory, including, for example, read-only memory, flash memory, magnetic or optical storage devices, or the like.

The control circuit 40 can also be and/or include one or more microprocessors, microcontrollers, Application Specific Integrated Circuits (ASICs), or other programmable devices. The control circuit 40 can be configured to execute program code stored within the memory circuit.

The control circuit 40 can be configured to convert the incoming video stream. The conversion can include calculating a corresponding RGB luminance value for each pixel 22. This includes converting red, green, and blue sub-pixel values to a luminance value for the pixel 22. One formula for calculating the luminance value for each pixel 22 includes:

L=0.3R+0.6G+0.1B (Eq. 1)

L is the RGB luminance value

R is the value of the red sub-pixel

G is the value of the green sub-pixel

B is the value of the blue sub-pixel

An example of the sub-pixel values would be a value within 2⁸ (i.e., a range of 0-255). The red, green, and blue sub-pixel values can be obtained from the incoming video stream received by the control circuit 40.

In one design, the control circuit 40 calculates the luminance values using shift operations. This simplifies and reduces the overhead required due to fewer logic blocks which can be performed by a less robust FPGA.

A variety of different methods can be used to calculate the brightness setting of the LED backlight 30. These include: average zone luminance; black level improvements for stray on pixels; black level control for halo improvement; and max frame brightness.

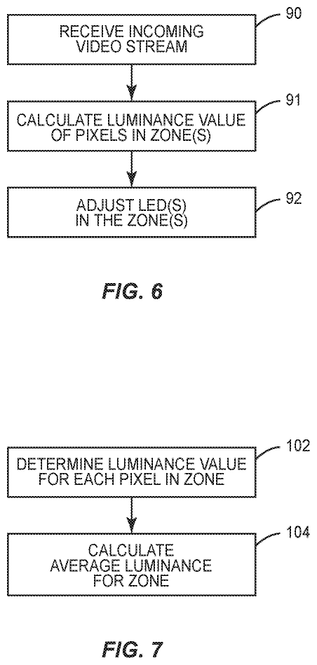

FIG. 6 illustrates a method of displaying an image. The method includes receiving an incoming video stream (block 90). From this data, a luminance value of pixels 22 is calculated for one or more zones 33 (block 91). Based on the luminance values, one or more of the LEDs 32 can be adjusted in one or more of the zones 33 (block 92).

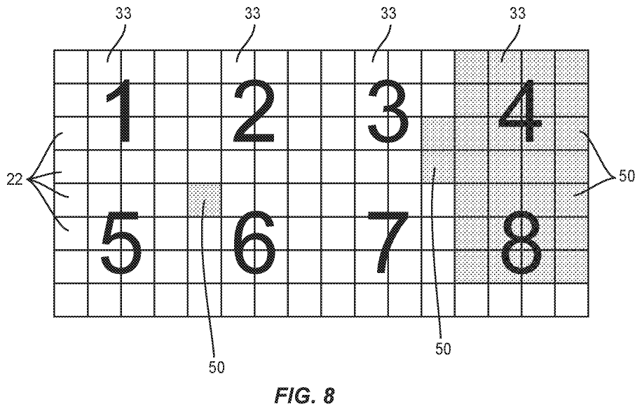

One method includes calculating an average zone luminance. The average zone luminance method sets the brightness of each of the LEDs 32 in a zone 33 based on the average luminance of the pixels 22 in the zone 33. FIG. 7 illustrates a method that includes determining a luminance value of each pixel 22 in the zone 33 (block 102). The values can be calculated using Equation 1. An average luminance value for each zone 33 is then calculated (block 104). This includes summing the luminance value for each pixel 22 in the zone 33 and then dividing by the number of pixels 22 in the zone 33. In one method, the pixels 22 are averaged along each row of the LCD array 21. The control circuit 40 maintains a running average for each zone 33 which is maintained until each row has been averaged.

The average luminance value for the zone 33 can be translated into a 12-bit or 16-bit value. The value can be a grayscale value that will dim the LEDs 32 of the zone 33 to various settings. Specific designs include 12-bit or 16-bit setting. Other designs can include other values, such as 4-bit setting. In one design, the output to the LED backlight 30 can use a SPI interface and is output to an LED controller of the LED backlight 30. The LED controller receives the output and controls the setting of corresponding LEDs 32.

Another method includes black level improvements for stray on pixels 22. This black level improvement method reduces to zero a brightness value for an LED 32 in a zone 33 when just a small number of pixels 22 within a zone 33 are non-black. This reduces and/or prevents a halo effect from forming around large objects on the display 10.

FIG. 8 illustrates an embodiment that includes pixels 22 aligned over eight LED zones 33 (that are numbered 1-8). An object 50 is displayed in the pixels 22 (shown as shaded pixels). As illustrated, the object 50 extends within a limited number of the zones 33 (i.e., just in zones 3, 4, 6, and 8). Pixels 22 that do not display the object 50 are black (these pixels 22 are shown with no shading in FIG. 8). The object 50 is sized and positioned with just a limited number of pixels 22 being non-black in zones 3 and 6. Specifically, zone 3 includes two non-black pixels 22 and zone 6 includes one non-black pixel 22. Instead of having the corresponding LEDs 32 illuminated for zones 3 and 6, the LEDs 32 in each of these zones 33 is turned off because the number of non-black pixels 22 is below a predetermined number.

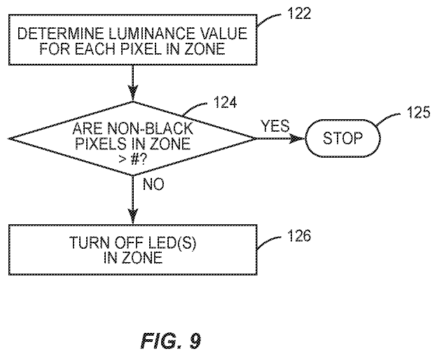

FIG. 9 includes a method to control the stray on pixels 22. The method includes determining the luminance value for each of the pixels 22 in the zone 33 (block 122). This can include using the calculations from Equation 1. The number of non-black pixels 22 in each zone 33 is determined and compared to a predetermined threshold (block 124). If the number of non-black pixels 22 (i.e., pixels 22 that are on to form part of a displayed object 50) is above the predetermined threshold, the method stops (block 125). If the number of non-black pixels 22 is below the predetermined threshold, the corresponding LED(s) 32 is turned off for that zone 33 (block 126).

The predetermined threshold of non-black pixels 22 can vary. This can include a fixed number (e.g., 5 pixels) or a percentage of pixels 22 in a zone (e.g., 5% of the pixels). Further, the method can be used for each of the zones 33 in the LED backlight 30, or a limited number of zones 33. The predetermined threshold can be the same or different for the different zones 33.

Another method is black level control for halo improvement. This method improves black levels and builds on the concepts of the previous method of black level improvements for stray on pixels. In general, this method focuses on and mitigates image data that would cause a halo to be displayed around an object. The brightness of a zone 33 is reduced when a small portion of the pixels 22 are non-black (i.e., on and displaying the image). This can include reducing the brightness of the LEDs 32 of a zone 33 to zero, or to a lesser level than that indicated by the image data. This reduction reduces the halo effect around large, bright objects. The small number of non-black pixels can include a fixed number in a zone 33 (e.g., 5 pixels) or a percentage of pixels in a zone 33 (e.g., 5% of the pixels). This method can also be used for each of the zones 33 in the LED backlight 30, or a limited number of zones 33.

In the method, a zone 33 is identified as being bright based on the calculated luminance value of the zone 33. The calculated luminance value of the zone 33 can include the average zone luminance described above. If the luminance value is above a predetermined threshold, the zone 33 is determined as being bright and is identified as the base zone 33. The method traverses around the base zone 33 to determine if nearby zones 33 are above or below a brightness threshold. These adjacent zones 33 are then analyzed to determine if the setting of the LED 32 should be adjusted. The method can be performed at multiple locations on the LED backlight 30 and can identify multiple base zones and corresponding nearby zones.

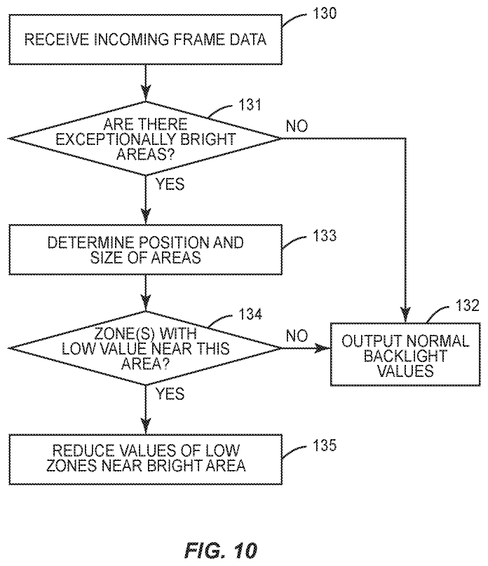

FIG. 10 includes a method of black level control for halo improvement. The frame data is received by the control circuit 40 (block 130). The brightness of the zones 33 is then calculated, such as by determining an average zone luminance.

It is then determined whether any areas are exceptionally bright (block 131). The areas can include one or more zones 33. Various calculations can be made to determine brightness. One method sets a fixed brightness value and zones 33 above the fixed value are considered exceptionally bright. Another calculation determines an average brightness of the zones 33 and determines if any of the zones 33 exceed the value by a predetermined amount (e.g., 25% greater, 50% greater). If no zones 33 are determined to be exceptionally bright, the LEDs 32 are not adjusted (block 132).

If one or more zones 33 are determined to be exceptionally bright, the position and size of these one or more zones 33 is determined (block 133). In one design, the frame data received in the incoming data includes coordinate information including x and y coordinates stored in a 2D array. The location of the one or more zones 33 can be calculated using this coordinate information.

The method includes determining if there are one or more zones 33 near the one or more identified bright zones 33 that include a low brightness (block 134). The determination of nearness can include but is not limited to the one or more zones 33 that are adjacent to the area, and the one or more zones 33 that are within a predetermined distance based on the 2D array values. If there are no zones 33 with a low value, the LEDs are not adjusted (block 132).

If there are nearby zones 33 with a low brightness value, the LEDs 32 are turned off for these one or more zones (block 135).

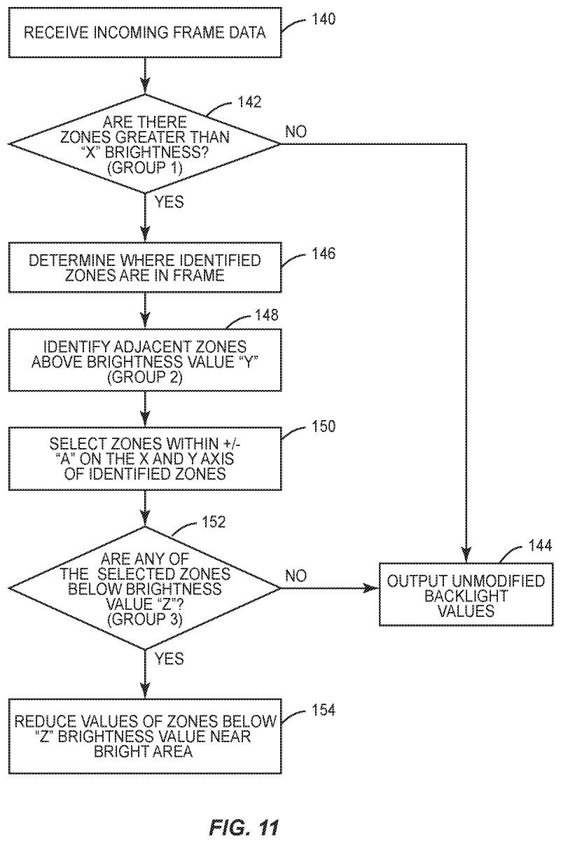

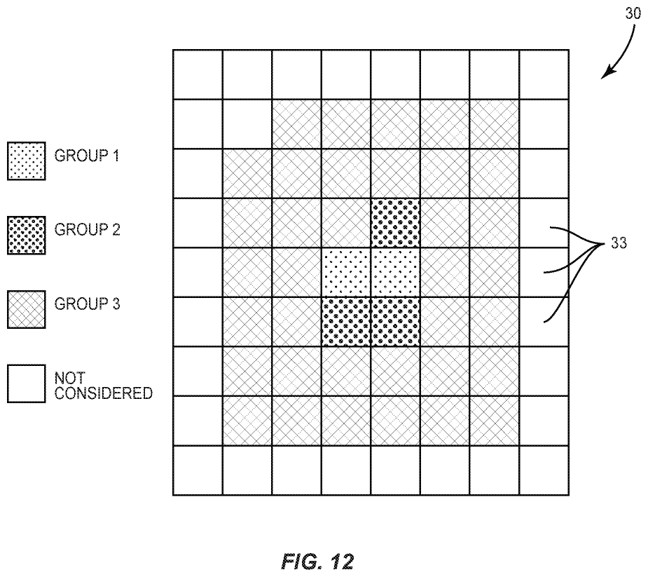

FIG. 11 displays another method of black level control for halo improvement. FIG. 12 illustrates an example of a LED backlight 30 with various zones 33. This method includes three brightness level thresholds. X is a very high value. Y is a high value that is slightly lower than X. Z is a very low value. The variable “a” is the range along the x- and y-axes the control circuit 40 will check for low brightness values to reduce to zero.

The incoming frame data is received by the control circuit 40 (block 140). The brightness of each of the zones 33 is calculated. Various methods can be used to calculate the brightness, including but not limited to determining an average zone luminance.

The method determines whether any of the zones 33 have a brightness that is greater than the first brightness threshold X (block 142). These zones 33 can be referred to as Group 1. The first predetermined threshold X can be set at various levels. If no zones 33 exceed the first predetermined threshold (i.e., no bright zones), the LEDs 32 are not adjusted (block 144). In the example of FIG. 12, two zones include a brightness above the threshold X and are Group 1 zones.

If one or more zones 33 exceed the first predetermined threshold X (i.e., one or more zones are bright zones), the location of the one or more Group 1 zones 33 is determined (block 146). In one embodiment, the location of the zones 33 is maintained in a 2D array which can be accessed by the control system 40 and used to determine the location of the Group 1 zones 33.

In addition to locating the one or more Group 1 zones 33, adjacent Group 2 zones 33 that have a brightness above the second predetermined threshold Y are identified (block 148). This step expands the area of interest and creates a full bright area. These Group 2 zones 33 are adjacent to the bright zones 33 and above the threshold Y. In the example of FIG. 12, three Group 2 zones 33 are included as adjacent zones.

Group 3 zones 33 are also identified. The Group 3 zones are within the predetermined distance A of the Group 1 and 2 zones (block 150). These additional zones 33 are used to identify the full area that that a bright object and/or glow from a bright object displays on the display 10. It is then determined if any of these Group 3 zones have a brightness below the third predetermined threshold Z (block 152). If none of the Group 3 zones are below the third predetermined threshold, the backlight values are not changed (block 144). For any of the Group 3 zones 33 that are below the third predetermined threshold, the LEDs 32 of these Group 3 zones 33 are turned off and the brightness reduced to a value of zero (block 154).

Another method is a maximum frame brightness. The max frame brightness method reduces the brightness of each of the zones 33 when the overall liquid crystal cell 20 is consuming too much power.

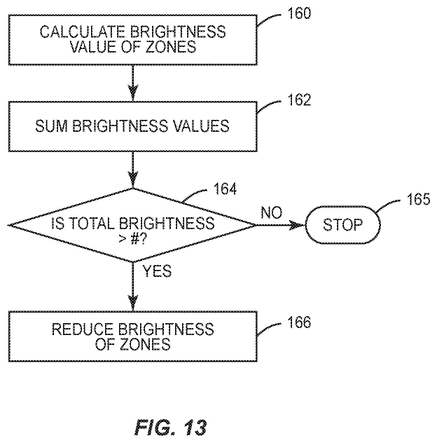

FIG. 13 illustrates the method that includes calculating a brightness value of each of the zones 33 (block 160). The brightness values are then summed (block 162). This determines the overall brightness value of the LED backlight 30. The overall brightness value is compared to a predetermined number (block 164). If the overall brightness value is less than the predetermined number, the method stops (block 165). If the overall brightness value is greater than the predetermined number, the brightness of each LED 32 is reduced (block 166). The amount of the reduction can vary. In one design, the amount of reduction is equal to the amount by which the predetermined number is exceeded. In one specific example, the predetermined number is 40 and the overall brightness value is calculated to be 44. Thus, the overall brightness is 10% over the predetermined number. The luminance of each LED 32 is reduced by 10%.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method of displaying an image on a liquid crystal display, the method comprising:
receiving an incoming video stream for displaying the image on the liquid crystal display, the liquid crystal display comprising a liquid crystal cell with an array of pixels and a light emitting diode (LED) backlight that comprises a plurality of LEDs that backlight the pixels, the liquid crystal display comprising zones that each comprise a portion of the array of pixels and one or more of the LEDs that backlight the portion of the pixels;
calculating a luminance value of the pixels in a first one of the zones; and
responsive to the luminance values, adjusting the one or more LEDs that backlight the pixels in the first one of the zones.

2. The method of claim 1, wherein calculating the luminance value of each of the pixels in the first one of the zones comprises:
calculating a first portion by factoring a red sub-pixel of the pixel with a first variable;
calculating a second portion by factoring a green sub-pixel of the pixel with a second variable;
calculating a third portion by factoring a blue sub-pixel of the pixel with a third variable; and
summing the first, second, and third portions to obtain the luminance value for the pixel;
wherein a sum of the first, second, and third variables is equal to one.

3. The method of claim 1, further comprising:
calculating an average zone luminance within the first one of the zones; and
adjusting a brightness of each of the one or more LEDs in the first one of the zones to a single value based on the average luminance value.

4. The method of claim 3, further comprising adjusting the brightness value of one or more LEDs that backlight the pixels in a second one of the zones to a different level than the first one of the zones.

5. The method of claim 1, further comprising reducing a brightness of the one or more LEDs in the first one of the zones when a predetermined threshold of the pixels in the first one of the zones does not display an object.

6. The method of claim 1, further comprising:
determining the pixels in the first one of the zones that display an object; and
when the pixels that display the object does not exceed a predetermined threshold, turning off the one or more LEDs that backlight the pixels in the first one of the zones.

7. The method of claim 6, further comprising maintaining the brightness of the one or more LEDs that backlight the pixels in the first one of the zones when the number of pixels that display the object exceeds the predetermined threshold.

8. The method of claim 5, wherein the zone is a first zone in the LCD display, and further comprising adjusting the one or more LEDs in a second zone that is adjacent to the first zone in a different manner than the one or more LEDs in the first zone.

9. The method of claim 5, further comprising reducing the brightness of the one or more LEDs in the first one of the zones to zero.

10. The method of claim 1, further comprising:
determining that the luminance value of the first one of the zones is above a predetermined threshold;
determining a position and size of the first one of the zones;
determining the luminance value of one or more additional zones that are within a predetermined distance of the first one of the zones; and
reducing the one or more LEDs of each of the additional zones that are below a luminance threshold.

11. The method of claim 10, wherein determining the luminance value of the one or more additional zones that are within the predetermined distance of the first one of the zones comprises determining the luminance value of the one or more additional zones that are adjacent to the first one of the zones.

12. The method of claim 10, wherein reducing the one or more LEDs of each of the additional zones that are below the luminance threshold comprises turning off the one or more LEDs of each of the additional zones that are below the luminance threshold.

13. The method of claim 1, further comprising:
calculating the luminance value of the first one of the zones and a plurality of other zones;
calculating an overall brightness by summing the luminance value of each of the zones;
reducing a brightness of the one or more LEDs in the first one of the zones and the plurality of other zones when the overall brightness is above a predetermined threshold.

14. The method of claim 13, further comprising reducing the brightness of each of the one or more LEDs an equal amount.

15. A method of displaying an image on a liquid crystal display, the method comprising:
receiving an incoming video stream for displaying the image on the liquid crystal display, the liquid crystal displaying comprising a liquid crystal cell with an array of pixels and a light emitting diode (LED) backlight that comprises a plurality of LEDs that backlight the pixels, the liquid crystal display comprising zones that each comprise a portion of the array of pixels and one or more of the LEDs that backlight the portion of the pixels;
calculating a luminance value of the pixels in one or more of the zones; and
responsive to one or more of the luminance values, adjusting the one or more LEDs that backlight the pixels in one or more of the zones.

16. The method of claim 15, further comprising reducing a brightness of the one or more LEDs in a first one of the zones when a predetermined threshold number of the pixels in the first one of the zones displays an object.

17. The method of claim 15, further comprising adjusting the luminance of the one or more LEDs in a first one of the zones while maintaining the luminance of the one or more LEDs in a second one of the zones.

18. A device to adjust a display of an image on a liquid crystal display that comprises a liquid crystal cell with an array of pixels and a light emitting diode (LED) backlight with a plurality of LEDs that backlight the pixels, the liquid crystal display comprising zones that each comprise a portion of the array of pixels and one or more of the LEDs that backlight the portion of the pixels, the device comprising:
a control circuit configured to receive an incoming video stream, the control circuit configured to:
calculate a luminance value of the pixels in one or more of the zones; and
responsive to one or more of the luminance values, adjust a luminance of the
one or more LEDs that backlight the pixels in one or more of the zones.

19. The device of claim 18, wherein the control circuit is further configured to:
determine the pixels in one of the zones that display an object; and
when the pixels in the zone is less than a predetermined threshold, turning off the one or more LEDs that backlight the pixels in the zone.

20. The device of claim 18, wherein the control circuit is further configured to:
calculate an overall brightness of the LCD display by summing a luminance value of each of the zones; and
reducing a brightness of the one or more LEDs in the zones when the overall brightness is above a predetermined threshold.
